(19) United States
(12) Patent Application Publication
(10) Pub. No.: US 2022/0193617 A1
(43) Pub. Date: Jun. 23, 2022

(54) METHOD FOR MANUFACTURING A MEMBRANE WITH HIGH PERCOLATION POWER

(71) Applicant: INSTITUT MINES TELECOM, Palaiseau (FR)

(72) Inventors: Thierry VINCENT, Allegre Les Fumades (FR); Eric GUIBAL, Deaux (FR)

(73) Assignee: INSTITUT MINES TELECOM, Palaiseau (FR)

(21) Appl. No.: 17/604,906

(22) PCT Filed: Apr. 24, 2020
(86) PCT No.: PCT/FR2020/050701

§ 371 Date: Oct. 19, 2021

(30) Foreign Application Priority Data
Apr. 24, 2019 (FR) 19/04290

(51) Int. Cl. B01D 67/00; B01D 69/14; B01D 71/08; B01D 71/60

(52) U.S. Cl. CPC B01D 67/0006; B01D 67/0009; B01D 69/148; B01D 2325/02; B01D 71/60; B01D 2323/30; B01D 2325/48; B01D 71/08

(57) ABSTRACT

A method for manufacturing a membrane, which includes at least the following steps of: preparing a mixture that contains at least an aqueous solution of a cationic polymer whose pH is between 5 and 8, the cationic polymer having positively-charged groups in this aqueous solution, and an aqueous solution of an anionic polymer, the anionic polymer having negatively-charged groups in this aqueous solution; stirring the mixture; leaving the mixture to mature to cause the ionic interaction between positively-charged groups of the cationic polymer and negatively-charged groups of the anionic polymer, until obtaining within the mixture a membrane in the form of a hydrogel; adding at least one crosslinking agent so as to crosslink the membrane; drying the crosslinked membrane obtained upon completion of the previous step. This membrane is used for the treatment of liquid or gaseous effluents, as well as an antimicrobial support or for heterogeneous catalysis.

The invention concerns a method for manufacturing a membrane with high percolation power thanks to a high macroporosity.

The unitary steps of process engineering applied in field such as waters and gases treatment, supported catalysis, the implementation of antimicrobial supports require a good management of the matter transfer, reactivity, filtering and percolations properties. The implementation of fine (nano- or micrometric) particles allows optimizing the transfer properties yet at the expense of a complexification of the separation and confinement processes.

The treatment of metal-derived effluents often implements processes like chemical reduction, chemical or electrochemical precipitation, solvent extraction techniques, electrocoagulation, membrane processes, adsorption on ion-exchange or chelating resins, or on mineral or organic adsorbents, both in the laboratory and in the industry. Nonetheless, these processes often encounter cost (competitiveness), wastes and byproducts production, or efficiency (with regards to discharge standards) problems that limit the application thereof.

In the context of waters treatment and more particularly of metallic ions fixation, conventional (industrial) ion-exchange resins often require complex synthesis processes.

Sorption is the technique that is the simplest, the most efficient and the least expensive to implement. Adsorbents commonly used for sorption include materials such as activated charcoal. However, these materials have the drawbacks of being barely stable, of having poor mechanical properties, of being difficult to recover upon completion of the sorption thereby generating a 2^{nd} source of pollution.

The filtering membranes (in particular those used in membrane processes such as micro-filtering, ultra-filtering, reverse osmosis) form an interesting alternative to these techniques. Nevertheless, their life cycle in particular their elimination at the end of the cycle) generates toxic pollutants (such as volatile organic compounds) which require controlled destruction processes. Moreover, some drawbacks might limit the use thereof: flow rates, cost, clogging phenomena. The generation of large volumes of concentrates that are difficult to recover also forms a limitation.

Furthermore, the percolation properties of current filtering membranes sometimes become difficult (in particular depending on their porosity, the presence of particles in suspension) by pressure drops and/or clogging problems.

An alternative to these materials consists in making «sponge»-type filtering membranes providing both a filtering structure (for a simplified and energy-efficient implementation: gravity percolation, for example), as well as a specific reactivity associated to the presence of functional groups.

In conventional methods, the techniques for manufacturing these membranes may implement:
freezing and lyophilization or drying (for example in supercritical carbon dioxide conditions) steps which are extremely energy-intensive; and/or
complex steps for generating adequate porosities for applications in gravity treatment of effluents.

Hence, these different drawbacks make the manufacture of these membranes merely interesting for large-scale production.

Moreover, besides making of adsorbent supports, the manufacture of adsorbent sponges with high macroporosity could find applications in supported catalysis. Indeed, the immobilization of complex and expensive catalytic formulations requires a good confinement of these metallic or organometallic phases, with optimized material transfer properties for the optimization of the conditions and performances of catalytic reactions.

As example, until very recently, the supports on which palladium nanoparticles were immobilized have consisted of inorganic materials such as mesoporous silica, zeolites and activated charcoal. However, with such materials, the palladium nanoparticles have often been leached during the chemical reaction; which has led to catalyst losses. Furthermore, the losses of such catalysts used to be increased as they could not be easily recovered upon completion of the chemical reaction, and that being so despite the implementation of separation techniques (centrifugation and filtering) that are expensive in terms of time and energy, and therefore making the catalytic support based on inorganic material merely effective for the use thereof on an industrial scale. Hence, making the synthesis of heterogeneous catalysts evolve towards new supports aims for a better efficiency and for recovery of expensive and rare resources.

That is why, in the field of heterogeneous catalysis, there has been a trend towards the use of polymer-based supports in order to overcome these drawbacks of catalyst losses observed with conventional supports.

The inventors have overcome all these drawbacks detailed hereinabove regarding the filtering materials intended for a wide variety of applications including in particular the treatment of liquid effluents, but also the use thereof as supports (whether functionalized or not) for heterogeneous catalysis or for antimicrobial products.

Indeed, the inventors have developed a new method for manufacturing a membrane with high percolation power that perfectly meets these objectives.

The invention concerns a method for manufacturing a membrane which comprises at least the following steps of:

a) preparing a mixture that contains at least:

an aqueous solution of a cationic polymer whose pH is comprised between 5 and 8, said cationic polymer having positively-charged groups in this aqueous solution;

an aqueous solution of an anionic polymer, said anionic polymer having negatively-charged groups in this aqueous solution;

b) stirring the mixture;

c) leaving the mixture to mature to cause the ionic interaction between positively-charged groups of the cationic polymer and negatively-charged groups of the anionic polymer, until obtaining within the mixture a membrane in the form of a hydrogel;

d) adding at least one crosslinking agent so as to fix the structure of the membrane;

e) drying the crosslinked membrane obtained upon completion of step d).

According to the invention, it has been determined that a range of pH values spanning from 5 to 8 was optimum for the cationic polymer to have positively-charged groups and at the same time for the mixed anionic polymer to have negatively-charged groups, ready to interact. Within this range, a person skilled in the art is capable of determining the pH as a function of the pKa of the polymers.

Preferably, the cationic polymer has a molecular weight greater than 40,000 g/mol. Furthermore, it has positive charges over a wide pH range comprised between 5 and 8.

The cationic polymer may be selected amongst polyethylenimine (hereinafter abbreviated as «PEI»), polyallylamine hydrochloride, chitosans and proteins (for example gelatins).

Preferably, the anionic polymer has a viscosity comprised between 0.4 and 0.5 Pa·s for a solution at 1 weight % of this polymer. Furthermore, it advantageously has negative charges at a neutral or slightly acid pH (namely for pH values comprised between 5 and 7).

The anionic polymer may be selected amongst polyacrylic acid, pectin, carrageenan, alginate and polystyrene sulfonate.

The mixture of step a) may comprise, in weight percent expressed with respect to the weight of said mixture:

between 0.2% and 0.5%, preferably between 0.28% and 0.4%, of the cationic polymer;

between 0.6% and 1.5%, preferably between 0.8% and 1.2%, of the anionic polymer.

Step a) may be carried out by progressively adding the aqueous cationic polymer solution in a vessel containing the aqueous anionic polymer solution.

Optionally, at step a), at least one solid compound is added to the mixture. This solid compound may be selected amongst activated charcoal, silica and clay. This solid compound will confer new reactive functions or new features on the membrane. Indeed, these examples of solid compounds are porous and carry functional groups having different affinities with respect to the contaminants; which allows enlarging the possible applications of the membrane. Moreover, their porous and/or polar/apolar characteristics may confer properties for immobilizing organic compounds (for example essential oils, perfumes or any chemical compound used for liquid/liquid extractions). Thus, starting from a membrane obtained with the manufacturing method according to the invention and upon completion of a step of impregnating organic molecules, this allows making an impregnated support for the controlled diffusion of molecules (a fragrance diffuser for example) or an impregnated membrane that could be applied in conventional extraction processes such as porous membranes immobilizing liquids/solvents extractants or ionic liquids.

Preferably, the solid compound is rehydrated before introduction thereof into the mixture in order to facilitate scattering thereof in this mixture which is viscous because of the presence of the two polymers.

Should at least one solid compound be added, this addition represents, in weight percent expressed with respect to the dry weight of the membrane between 0.05% and 1.2%. More specifically, when the compound consists of activated charcoal or silica, the weight percentage may be comprised between 0.05% and 0.4%, preferably between 0.1% and 0.3%. When it consists of clay, the weight percentage may be comprised between 0.4% and 1.2%, preferably between 0.5% and 0.8%.

Step b) may be carried out at room temperature with stirring at a speed comprised between 16,000 rpm and 22,000 rpm, preferably between 19,000 rpm and 21,000 rpm.

The duration of step b) may be comprised between 30 seconds and 2 minutes, preferably between 40 seconds and 80 seconds.

Upon completion of step b), the mixture could be casted in a mold (for example a polypropylene box) and the maturation step c) is then performed. The geometry of the mold will impart a shape to the membrane that will be obtained upon completion of the method according to the invention. The various geometries of the molds allow producing membranes of different shapes and of different dimensions.

During step c), a membrane in the form of a hydrogel is formed within the mixture because the ionic interaction between positively-charged groups of the cationic polymer (for example the amine functions of PEI, or of a chitosan) and negatively-charged groups of the anionic polymer (for example the carboxylic functions of alginate or the sulfonic functions of a carrageenan). By hydrogel, it should be understood according to step c), a material forming a humid membrane and constituted by a network of the both cationic and anionic polymers. This polymer network has a structure that does not result from an ionotropic gelation, but rather from ionic bonds between aforementioned groups with opposite charges and which already features some macroporosity.

Step c) could be carried out over a range of temperatures varying between −80° C. and 50° C. (therefore including freezing of the mixture for the negative temperatures). This is not crucial for the interaction between positively-charged groups of the cationic polymer and negatively-charged groups of the anionic polymer to take place. Thus, it could be carried out at room temperature, at a temperature comprised between −10° C. and −30° C. In this last embodiment, a mechanically stable membrane with a remarkable elasticity is obtained (namely it could withstand significant distortions).

In the case of freezing, thawing occurs at step d) during which the crosslinking agent is added.

However, the temperature of step c) has an influence on the reaction kinetics (or in other words on the quality of the ionic interactions between the cationic polymer and the anionic polymer), and consequently on the membrane structuring process; which induces the textural characteristics (in particular macroporosity characteristics) of the membrane obtained according to the manufacturing method according to the invention.

During step c), advantageously, all of the charged groups of the cationic and anionic polymers, respectively, do not necessarily interact. Indeed, free groups (or charged depending on the targeted application) shall subsist for the subsequent step d) of crosslinking, according to the desired crosslinking, but also because of their involvement depending on the use that is made afterwards of the membrane derived from the method of the invention. Of course, it is within the reach of those skilled in the art to adapt the conditions of step c) to the quality of the expected membrane. Thus, if it is used to retain metallic ions, it should be ensured that reagent groups (the cationic and anionic groups of the starting polymers) remain free. As example, and depending on the field of application of a membrane of the invention, it could be considered that the ratio of positively-charged groups and/or negatively-charged groups that have remained free is lower than or equal to 50%, for example 30-50%. Should it be necessary to monitor this ratio, a person skilled in the art, based on his general knowledge, could in particular act on the ratio of the concentration of the cationic polymer to that of the anionic polymer, throughout step b).

Optionally, between step c) and step d), the membrane is washed at least once with water, preferably with demineralized water. This allows eliminating the reagents and monomers that have not reacted among the different constituents at step c), as well as the labile portions.

During step d), at least one crosslinking agent is added into the mixture that contains the membrane in the form of a hydrogel of step c). This step of crosslinking the network formed at step c) generates and additional meshing to form a new crosslinked network which then contributes in reinforcing structuring of the membrane and in particular in fixing the porous network. This additional meshing could be the result of a crosslinking of the chains of the cationic polymer with one another, of a crosslinking of the chains of the anionic polymer with one another, or of a crosslinking of the chains of the cationic polymer and of the chains of the anionic polymer, depending on the crosslinking agent that is used, or even a combination of these mechanisms with the implementation of several crosslinking agents. It should be understood that crosslinking occurs between neighboring chains. A person skilled in the art is capable of selecting the crosslinking agent(s) for this step, in particular according to the application for which the manufactured membrane with high percolation power is intended. It should be noticed that this step d) may involve groups of said cationic and/or anionic polymers, which are also the groups involved in step c); hence, in this case, all these groups should not be engaged at step c).

Thus, to crosslink the chains of the cationic polymer together, the crosslinking agent is properly selected according to the nature of the cationic polymer. The crosslinking agent may consist of glutaraldehyde.

For example, when the cationic polymeric consists of PEI, during the addition of glutaraldehyde, the aldehyde function of the latter will react with the free amine functions of PEI. This consists of a Schiff base type reaction.

The weight percentage of the crosslinking agent may be comprised between 0.1% and 1%, with respect to the weight of the mixture of step a). When the mixture comprises solid compounds as described hereinabove, the weight percentage of the crosslinking agent is advantageously comprised between 0.1% and 0.6%.

At step d), the crosslinking agent is advantageously added to the mixture under slow stirring (for example by subjecting the mixture to a «back-and-forth» movement: between 20 and 24 movements per minute).

Optionally, between step d) and step e), the crosslinked membrane is washed at least one with water, preferably with demineralized water. This allows eliminating the reagents and monomers that have not reacted among the different constituents, as well as the labile portions.

At step e), the membrane obtained in this manner is dried. Advantageously, drying is carried out at room temperature under an air stream (for example with an extraction hood). This process does not require any complex and energy-intensive device; which makes the method according to the invention unique and interesting. A macroporous and homogeneous membrane is then obtained.

Nonetheless, should the applications of the membrane require so, it could be considered to perform a more sophisticated drying (for example by lyophilization or in supercritical CO₂ conditions) so as to obtain a membrane having a macroporous structure and whose surface is micro- or mesoporous.

All of the steps of the manufacturing method could be implemented at a temperature comprised between 4° C. and 50° C., preferably at room temperature (namely comprised between 15° C. and 25° C.) so as to obtain a homogeneous and macroporous membrane.

Upon completion of the manufacturing method according to the invention, we obtain a membrane that has the following properties:
an apparent density comprised between 0.02 g/cm³ and 0.1 g/cm³, preferably about 0.04 g/cm³;
a porosity such that the void percentage is comprised between 90% and 96%, preferably about 95%;
a water flux by natural percolation (namely without pressurization) comprised between 40 and 200 mL/cm²·min, preferably about 146 mL/cm²·min; namely a surface speed comprised between 24 and 120 mL/cm²·min, preferably about 87 m/h.

Thus, unlike the membranes of the prior art, the manufacturing method according to the invention has the advantage of requiring no sophisticated drying process to maintain the high porosity of the membrane. The method according to the invention involves simple steps of stirring, gelling and crosslinking, as well as drying at room temperature. It does not necessarily require a step of lyophilization or of production of a cryogel.

The sophisticated drying step as described hereinabove is perfectly optional in the context of the invention and is implemented only when it is desired to provide a membrane having a dual-structure, namely a macroporous structure and whose surface is micro- or mesoporous.

Moreover, the manufacturing method according to the invention has the advantage of obtaining a mechanically stable membrane with a good elasticity, in particular when at step c), the mixture is left to mature by freezing it.

The method according to the invention allows an easy manufacture of membranes in better energy conditions.

The invention also concerns a membrane with high percolation power that could be obtained by the method hereinabove, in particular as obtained by this method. Depending on the applications in which it is used and therefore the manufacturing method retained for this purpose, it could consist of an adsorbent membrane, it could also consist of a membrane involving no interaction of its groups.

The invention also relates to the use of the membrane obtained according to the manufacturing method for the treatment of liquid or gaseous effluents.

The invention also relates to the use of the membrane obtained according to the manufacturing method as a support for heterogeneous catalysis. This support has the advantage of allowing an easy recovery of the catalysts at the end of their service life thanks to an easy elimination of the membrane, for example by thermal degradation. Thus, this allows recycling of the precious metals that are used as catalyst for heterogeneous catalysis.

The invention also relates to the use of the membrane obtained according to the manufacturing method as an antimicrobial support. Indeed, the membrane can easily retain antimicrobial compounds such as metallic cations (for example Ag(I), Zn(II), Cu(II), Ni(II)) that have biocidal properties.

Moreover, the membrane may also have antimicrobial properties if it is chemically modified by grafting quaternary amines, for example at the level of the cationic polymer. This chemical modification could have been performed on the cationic polymer before the implementation of the manufacturing method according to the invention or before or after the drying step. Grafting of quaternary amines is perfectly within the reach of those skilled in the art, the same applies to these antimicrobial properties obtained thanks to the quaternization of cationic polymers.

The membrane obtained with the method according to the invention on which metallic cations have been adsorbed or which has been chemically modified by quaternization such that it has biocidal properties can thus be used as a filtering medium for microbial decontamination.

The invention will be better understood from the detailed description of experiments that are disclosed hereinbelow with reference to the appended drawing representing results of experimental data relating to the manufacturing method according to the invention.

### DESCRIPTION OF THE FIGURES

FIG. 1 represents a graph of the evolutions of the fixing capacity denoted «q_{eq}» of chromium(VI) (hereinafter abbreviated «Cr(VI)») and of the total chromium (hereinafter «Cr(total)») as a function of the residual concentration C_{eq} of Cr(VI) and Cr(total) respectively after experiments of adsorption of chromium ions on a membrane obtained according to a 1^{st} embodiment of the manufacturing method according to the invention.

FIG. 2 represents a captured photo of a membrane obtained according to a 2^{nd} embodiment of the manufacturing method according to the invention.

FIG. 3 is a graph representing the evolutions of relative residual concentration of palladium denoted «Ct/C0» for 3 membranes with different thicknesses and which have been obtained according to this 2^{nd} embodiment of the manufacturing method according to the invention as a function of the 3-nitrophenol (hereinafter abbreviated «3-NP») hydrogenation reaction time.

FIG. 4 is a graph of the model of the kinetic profiles by the pseudo-first order equation (In(Ct/C₀)) as a function of the reaction time plotted based on the reported relative residual concentrations of palladium.

FIG. 5 represents a graph of the breakthrough curves obtained with other 3-NP hydrogenation reaction experiments.

FIG. 6 represents a microphotograph of a membrane produced according to the invention illustrating the macroporosity of the material (scanning electron microscope).

FIG. 7 represents a captured photo illustrating the high percolation power (by gravity drainage) of a membrane produced according to the invention when a liquid is flowing.

FIG. 8 represents a captured photo of a membrane produced according to the invention (plate, 20×10 cm).

FIG. 9 represents a captured photo of the inner macroporosity of the membranes produced according to the invention (in section, after die cutting).

### EXPERIMENTAL PART

1^{st} Series of Experiments:

15 g of a PEI solution with a mass content of 50% have been diluted in 250 g of demineralized water. The pH of this solution has been set to a value of 6.5 with nitric acid. Thus, an aqueous PEI solution with a mass content of 3% has been obtained. 40 g of alginate have been diluted with 960 g of demineralized water so as to obtain an aqueous alginate solution with a mass content of 4%. 132 g of the alginate solution obtained in this manner have been mixed with 368 g of demineralized water.

The whole has been stirred, and then 35 mL of the PEI solution have been added (namely 5 mL every 10 seconds, this operation having been repeated 7 times).

The mixture has been stirred for one minute.

The mixture has been poured into a polypropylene box while avoiding the formation of bubbles and the whole has been left at room temperature for 24 hours. A membrane has been obtained through a gelling reaction of the alginate with PEI.

The membrane has been washed 5 times with demineralized water.

The washed membrane has been put in suspension in 300 mL of demineralized water to which 4 mL of an aqueous glutaraldehyde solution with a mass content of 50% have been added so as to achieve crosslinking of the membrane.

Afterwards, the membrane has been subjected to a moderate stirring of 30 «back-and-forth» movements per minute for 24 hours.

The membrane has been rinsed (6 times) with 300 mL of demineralized water, and then dried at room temperature for 2 days.

Characterizations of the Obtained Membrane:

The membrane obtained in this manner had the following characteristics:
a porosity (measured with a pycnometer) of 93.4%;
a stability to attrition of 94%;
a water flux (in natural percolation) of 33.6 mL/(cm²·min);
a point of zero charge pH (hereinafter abbreviated as «pH_{PZC}») of 5.7.

The 93.4% value reflects a high porosity of the membrane which is quite adequate to ensure good natural percolation performances, as shown by the filtering flux (filtering surface speed in the range of 20 m/h).

The stability of the membrane has been determined by subjecting a sample of the membrane in the form of a disk with a diameter of 25 mm immersed in 20 mL of water to stirring at 150 rpm for 72 hours. Then, the membrane has been dried and weighted. Stability is the percentage of remaining membrane upon completion of this stirring with respect to the initial membrane mass. The 94% value reflects a very good stability of the membrane to attrition and a maintenance of its integrity when it is subjected to a strong stirring in water.

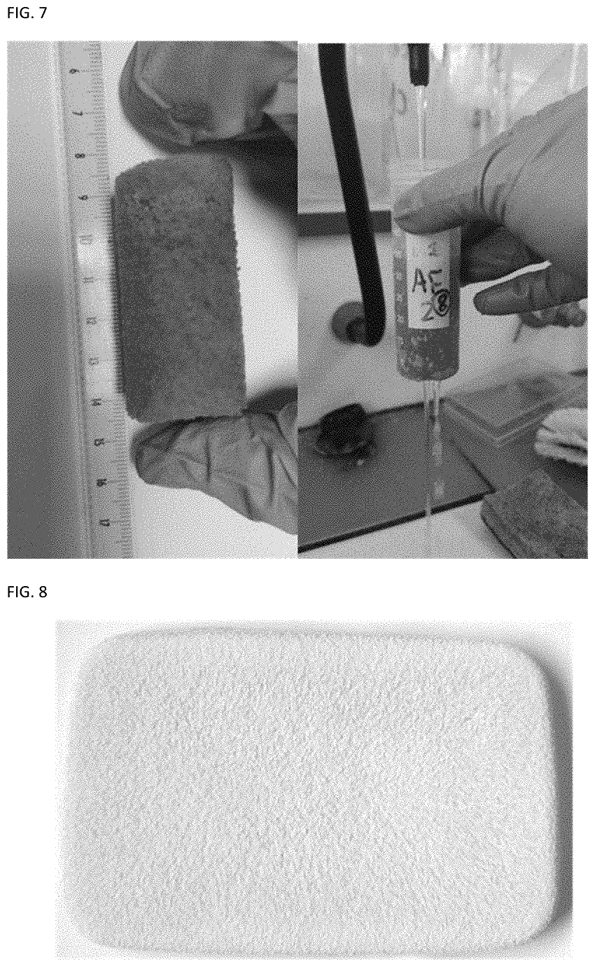

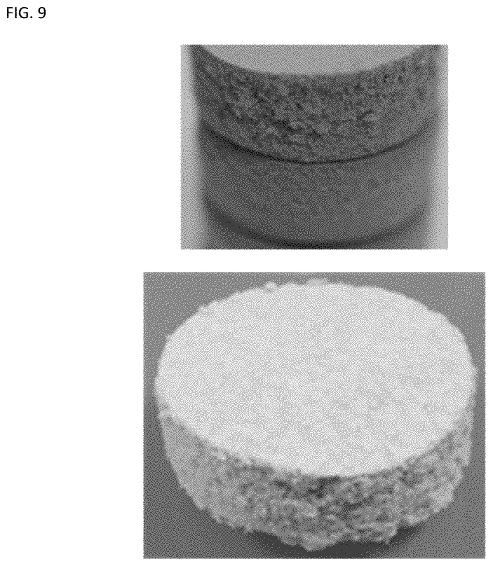

The water flux has been determined by measuring the time required for the passage of 100 mL of water throughout a membrane sample with a surface of 4.64 cm², and that being so at 20° C. and at a pressure of 0.006 bar. The value of the water flux (in natural percolation) of 33.6 mL/(cm²·min) reflects excellent percolation properties of the membrane. FIG. 7 illustrate the natural flow by gravity drainage throughout the macroporosity of the membranes with high percolation power.

Furthermore, the membrane obtained in this manner has been subjected to sorption experiments with a solution containing Cr(VI) ions in order to characterize its adsorption properties.

For this purpose, the device used for these experiments consisted of a device operating continuously for the recirculation of solutions containing metallic ions which comprised:
a peristaltic pump commercialized by the company Ismatec under the commercial name ISM404B;
a support configured to contain the membrane and enable the circulation of the solution of metallic ions throughout said membrane;
a reservoir containing the solution of metallic ions equipped with a magnetic stirrer commercialized by the company Thermo Scientific under the commercial name Variomag® Poly 15 to stir the solution;
a device for the loop circulation of the solution of metallic ions and the passage thereof throughout the membrane.

Throughout these experiments, the solution of Cr(VI) ions has been put to circulate in loop in the device with a pumping rate of 15 or 30 mL/minute.

Throughout these experiments, Cr(III) ions have appeared by reduction of the Cr(VI) ions in situ on the membrane.

The concentration of Cr(VI) has been determined with a UV spectrophotometer commercialized by the company Shimadzu under the commercial name UV-1650PC at a wavelength of 540 nm by means of a colorimetric method with diphenylcarbazone.

The total concentration of Cr (namely the sum of the Cr(VI) and Cr(III) ions) has been determined by atomic emission spectrometry with induced plasma with a spectrometer commercialized by the company Horiba under the commercial name Activa.

The concentration Cr(III) has been determined by subtraction of the concentration of Cr(VI) from the concentration of Cr(total).

The membrane has also been characterized by:
scanning electron microscopy with a microscope commercialized by the company Thermo Fisher Scientific under the commercial name Quanta™ FEG 200, so as to demonstrate the high porosity of the membrane;
energy dispersive analysis so as to reveal the dense and homogeneous distribution of metallic ions (chromium) within the membrane.

Photos Captured by Scanning Electron Microscopy:

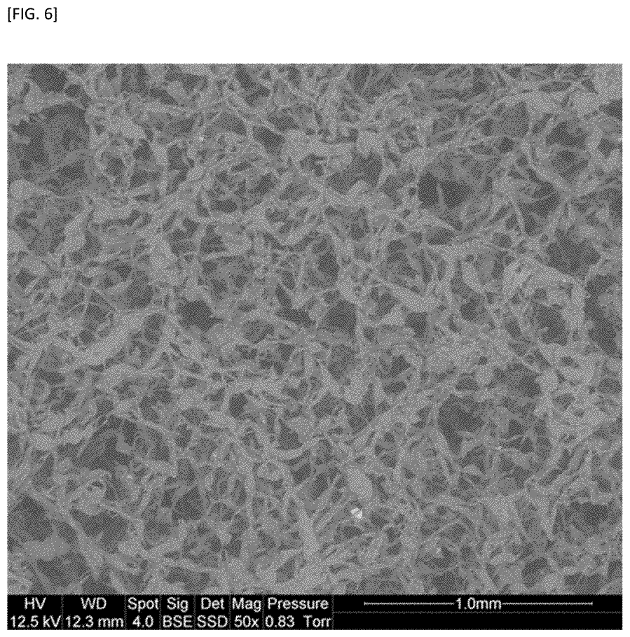

The photos captured by scanning electron microscopy have shown that the structure of the membrane obtained in this manner upon completion of the manufacturing method according to the invention was porous. More specifically, the observed porosity was irregular in terms of cell geometry but evenly distributed in the space and in terms of average size whose order of magnitude was between 100 and 200 μm. This is illustrated in FIG. 6.

After the membrane (a 30 mg sample) has been subjected to Cr(VI) sorption upon completion of a recirculation in the experimentation device as detailed hereinabove with an aqueous solution that contained Cr(VI) ions at a concentration of 200 mg/L at a pH of 2 for a duration of 96 hours with a recirculation feed rate of 15 mL/minute and at a temperature of 20° C., the photos captured by scanning electron microscopy have shown that the structure of the membrane was slightly more compact and always porous. This compression of the membrane could be explained by the liquid stream that has crossed the membrane and also by the reaction of Cr(VI) with the functional groups of the membrane during the adsorption thereof on the membrane such that Cr(III) ions have been formed in situ. Indeed, the partial reduction of Cr(VI) in situ could contribute to modifying the apparent structure of the membrane by causing oxidation thereof.

Energy Dispersive Analysis Spectrum:

The energy dispersive analysis spectrum after this sorption experiment has shown the homogeneous presence of chromium ions at the surface of the membrane. This confirms the adsorbent properties of the membrane obtained with the manufacturing method according to the invention.

Adsorption Isotherm (at Room Temperature) of Cr(VI) by the Membrane

The adsorption isotherm has been determined with the above-described device by making 50 mL of Cr(VI) solutions at a pH of 2 and at initial concentrations comprised between 20 and 300 mg/L circulate in loop at 20° C. and continuously for 96 hours. The circulation flow rate was 15 mL/minute.

Once equilibrium is reached, the filtrate recovered upon completion of the experiment has been analyzed in order to determine:
the residual concentration C_{eq} of Cr(VI), and
the residual concentration C_{eq} of Cr(total),

with the techniques as detailed hereinabove.

Through a material balance, the amounts of Cr(VI) and of Cr(total) that have been fixed on the membrane, as well as the corresponding fixing capacities (q_{eq}) have been deduced.

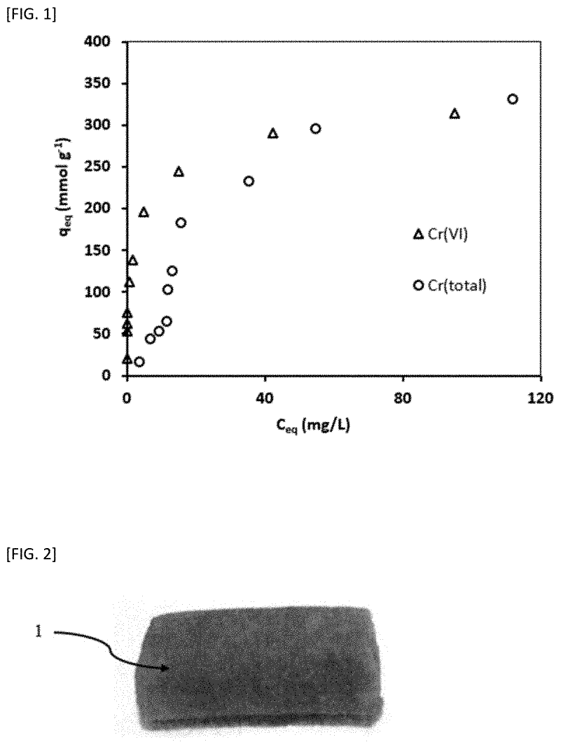

FIG. 1 is a graph of the evolutions of the fixing capacity q_{eq} of Cr(VI) and of Cr(total) as a function of the residual concentration C_{eq} of Cr(VI) and Cr(total), respectively. These plots allow obtaining the adsorption isotherms of Cr(VI) and of Cr(total) and deducing the maximum adsorption capacities (qₘₐₓ) of Cr(VI) and of Cr(total), as well as the affinity of the adsorbent for the solute (adsorbate) which is proportional to the slope at the origin of the curve.

In light of FIG. 1, the maximum adsorption capacity exceeds 300 mg of Cr(VI)/g. This maximum fixing capacity is very high (amounting to more than 6 mmol Cr(VI)/g of adsorbent). The slope at the origin for Cr(VI) is almost vertical. This proves the strong affinity of the membrane obtained with the manufacturing method according to the invention for chromate ions. The slope at the origin for Cr(total) is lower. This is to be related to mechanisms of reduction of Cr(VI) in situ on the membrane in acid medium.

Thus, these experiments of adsorption of chromium by a membrane obtained according to the manufacturing method according to the invention reflect its excellent adsorbent properties and therefore its potential for use thereof in the treatment of liquid effluents that contain Cr(VI) ions in particular.

2^{nd} Series of Experiments:

A volume of 100 mL of an alginate solution at 4 weight % has been diluted with 400 mL of demineralized water so as to obtain a 1^{st} solution.

A volume of 35 mL of a PEI solution at 4 weight % whose pH has been set to 6.5 with nitric acid has been progressively added under stirring to the 1^{st} solution (namely 5 mL every 10 seconds, this operation having been repeated 7 times).

After adding PEI, the mixture has been poured into a polypropylene box while avoiding the formation of bubbles and the whole has been left at room temperature for 24 hours. A membrane has been obtained through a gelling reaction of the alginate with PEI.

The obtained membrane has been washed 5 times with demineralized water in order to eliminate the free reagents.

300 mL of demineralized water have been added to the washed membrane, and then 2.5 mL of an aqueous glutaraldehyde solution with a mass content of 50% have been added so as to enhance crosslinking of the membrane.

Afterwards, the membrane has been subjected to a moderate stirring of 30 «back-and-forth» movements/minute for 24 hours.

The membrane has been washed 4 times with demineralized water, and then dried at room temperature for 2 days.

Characterizations of the Obtained Membrane:

The membrane obtained in this manner had the following characteristics:
a porosity (measured with a pycnometer) of 70.93%;
a stability to attrition of 97.0%;
a water flux of 24.8 mL/(cm²·min);
a pH_{PZC} of 6.29;
a density of 0.0637 g/cm³ (which reveals a high macroporosity of the membrane).

The stability has been determined in the same manner as with the 1^{st} series of experiments. The 97% value reflects a very good stability of the membrane to attrition and a maintenance of its integrity when it is subjected to a strong stirring in water.

The water flux has been determined in the same manner as with the 1^{st} series of experiments. The value of 24.8 mL/(cm²·min) reflects excellent percolation properties of the membrane.

FIG. 2 represents a photo of a sample of this absorbent membrane 1 which has been obtained in this manner. The sample measures 55 mm in length and has a diameter of 25 mm.

Use of the Membrane as a Catalysis Support for the Hydrogenation of 3-Nitrophenol Catalyzed with Palladium

Immobilization of Pd(II):

The membrane has been cut into disks with a diameter of 25 mm.

Afterwards, a disk (with a dry weight of 250 mg) has been disposed in the support configured to contain the membrane of the device described in the 1^{st} series of experiments so as to make a fixed-bed column.

One liter of a Palladium(II) solution (hereinafter abbreviated «Pd(II)») with a variable concentration, comprised between 10 and 50 mg/L, whose pH has been set to 1 with sulfuric acid has been put to circulate in loop within this device for 24 hours with a flow rate of 30 mL/min. The optimum conditions of palladium fixation on the membrane (in other words «the best maximum use efficiency of palladium») have been obtained when its concentration was 28 mg Pd/L.

After fixation of palladium, the column has been rinsed 4 times with demineralized water at a pH of 1. The membrane has not been dried before proceeding with the reduction of the metal.

The maximum fixing capacity of palladium reached with the membrane throughout these crosslinkings amounted to 224 mg Pd/g. This fixing capacity is much higher than that of the membranes known from the prior art which are used for catalytic experiments and which contain about 8.8 weight % of palladium.

Reduction of Pd(II) into Pd(0):

The reduction of Pd(II) immobilized on the membrane has been carried out by hydrazine hydrate (of chemical formula: N₂H₄.H₂O) at a concentration of 0.03 mol/L in 200 mL of an alkaline solution (at a concentration of 0.5 mmol/L of NaOH) under stirring at 60° C. for 5 hours.

A final rinsing (4 successive cycles) has been carried out in order to eliminate all traces of free reagents.

A membrane on which palladium has been adsorbed was obtained. This membrane is abbreviated hereinafter as «the catalytic membrane».

Photos Captured by Scanning Electron Microscopy and Coupling with Energy Dispersive Analysis:

The photos captured by scanning electron microscopy and the energy dispersive analysis (by semi-quantification) have shown that the structure of the membrane obtained in this manner was macroporous, relatively homogeneous at the surface and across the section thereof.

Observation with Transmission Electron Microscopy

The observations with transmission electron microscopy have shown a homogeneous distribution of the palladium nanoparticles at the surface of the membrane after the reduction of Pd(II) by hydrazine hydrate.

After reduction of the metal, the size of the palladium nanoparticles ranged between 4.5 and 10.5 nm.

Test of the Catalytic Properties of the Catalytic Membrane

Hydrogenation of 3-NP on the Membrane (with Recirculation)

The operative procedure used to test the catalytic properties of the catalytic membrane has been implemented with the recirculation device described hereinabove in the 1^{st} series of experiments.

The catalytic membrane has been fed in loop recirculation for 12 minutes with 100 mL of a 3-NP solution at 50 mg 3-NP/L whose pH has been set to 2.84 in the presence of formic acid at a concentration of 0.2 weight %. The concentration of formic acid has been set in molar excess relative to 3-NP (formic acid/3-NP molar ratio of 160/1). The recirculation flow rate was 50 mL/min.

The concentration of 3-NP has been measured by spectrophotometry at 332 nm. For this purpose, the collected samples have been acidified with 20 μL of a solution at 5 weight % of sulfuric acid prior to the spectrophotometry analysis.

3 experiments have been carried out with 3 catalytic membranes with different thicknesses:
1^{st} catalytic membrane with a thickness of 0.58 cm and with a mass of 175 mg over which 26.1 mg of palladium have been immobilized;
2^{nd} catalytic membrane with a thickness of 0.85 cm and with a mass of 255 mg over which 27.2 mg of palladium have been immobilized;
3^{rd} catalytic membrane with a thickness of 1.06 cm and with a mass of 313 mg over which 27.7 mg of palladium have been immobilized.

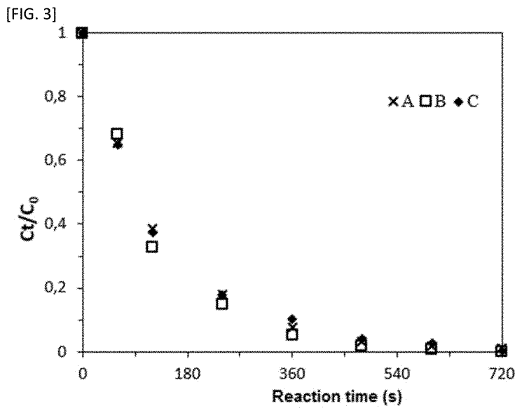

FIG. 3 is a graph representing the evolutions of the relative residual concentration of palladium denoted «(Cₜ/C₀)» as a function of the hydrogenation reaction time, for the 3 tested membranes:
1^{st} curve denoted «A» for the 1^{st} catalytic membrane;
2^{nd} curve denoted «B» for the 2^{nd} catalytic membrane;
3^{rd} curve denoted «C» for the 3^{rd} catalytic membrane.

Considering the similar aspect of the 3 curves A to C, it is concluded that the thickness of the catalytic membrane does not affect the kinetic profile of the reaction of hydrogenation of 3-NP catalyzed by palladium.

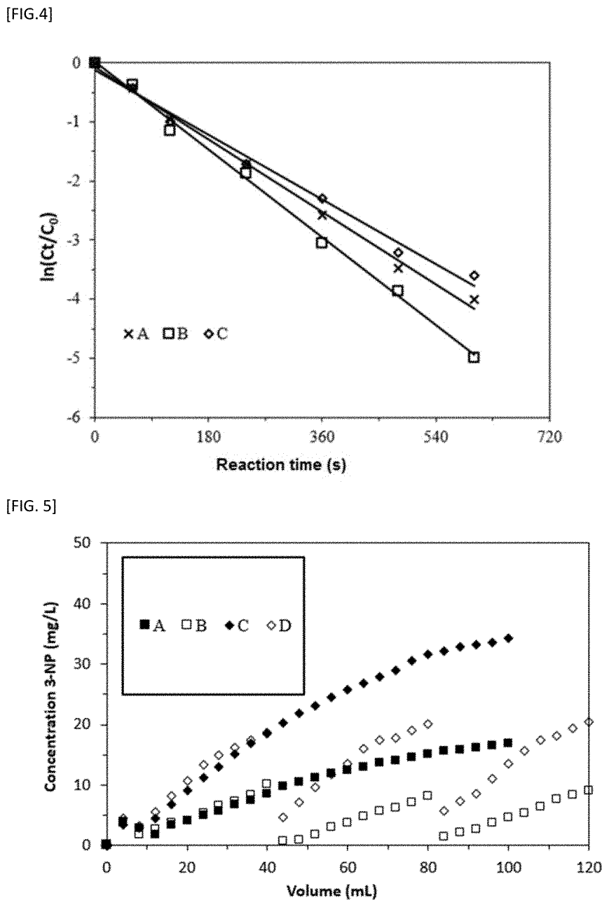

FIG. 4 is a graph of the model of the kinetic profiles by the pseudo-first order equation (In(Ct/C₀)) as a function of the reaction time for the 3 tested catalytic membranes:
1^{st} curve denoted «A» for the 1^{st} catalytic membrane;
2^{nd} curve denoted «B» for the 2^{nd} catalytic membrane;
3^{rd} curve denoted «C» for the 3^{rd} catalytic membrane.

This model has shown a limited variation of the 1st order kinetic coefficient. Indeed, this coefficient amounted to:
0.0061 s⁻¹ for the 1^{st} catalytic membrane;
0.0068 s⁻¹ for the 2^{nd} catalytic membrane;
0.0083 s⁻¹ for the 3^{rd} catalytic membrane.

These experiments show that the palladium nanoparticles remain available and the high percolation power of the membranes obtained with the manufacturing method according to the invention allows preserving a good accessibility which is independent of their thickness.

Furthermore, the analysis of these data has allowed calculating the rotation frequency value which is in the range of 0.1 mmol of substrate/(mmol Pd·minute).

Finally, assessment of the hydrogenation performance over thirty cycles with these 3 catalytic membranes has shown a very limited reduction of the hydrogenation rate: namely a decrease by less than 15%. A simple rinsing with demineralized water allows a regeneration of the membrane obtained with the manufacturing method according to the invention.

Hydrogenation of 3-Nitrophenol on the Membrane (Without Recirculation)—Effect of the Regeneration of the Support

The effects of the feed rate of 3-NP and of the regeneration of the membrane obtained according to the manufacturing method according to the invention have been studied.

For this purpose, increasing volumes (up to 120 mL) of a 3-NP solution at a concentration of 200 mg 3-NP/L at a pH of 2.7 with a circulation flow rate of 20 or 30 mL/minute have circulated (one single passage) throughout a sample of the membrane (27.2 mg).

Furthermore, the catalytic membrane has been fed into this 3-NP solution at these circulation flow rates of 20 or 30 mL/minute by while regenerating it (by simple rinsing with demineralized water using a volume corresponding to about 9 times the volume occupied by said membrane) when the volume of 3-NP that has circulated throughout the catalytic membrane has reached the values of 40 mL and 80 mL.

FIG. 5 represents a graph of the breakthrough curves obtained with these experiments. This consists of the evolution of the residual concentration of 3-NP as a function of the volume of the 3-NP solution that has passed throughout the catalytic membrane when:
the feed rate was 20 mL/minute (curve «A»);
the feed rate was 30 mL/minute (curve «B»);
the feed rate was 20 mL/minute and the membrane has undergone a regeneration after passage of 40 mL and 80 mL of the 3-NP solution (curve «C»);
the feed rate was 30 mL/minute and the membrane has undergone a regeneration after passage of 40 mL and 80 mL of the 3-NP solution (curve «D»).

The breakthrough curves reveal a progressive increase in the residual concentration of 3-NP as a function of the volume of the 3-NP solution that has passed throughout the catalytic membrane. The increase of the circulation flow rate increases the slope of the breakthrough curve (because of an insufficient stay-time in the catalytic membrane).

The interruption of feeding of the catalytic membrane and the regeneration thereof by means of demineralized water induces a break-up in the breakthrough curves and a partial resumption of its catalytic effectiveness.

This catalytic reaction of 3-NP hydrogenation clearly illustrates the possibility of using the membranes with high percolation power obtained with the manufacturing method according to the invention for the immobilization of catalytic metals and the synthesis of catalytic supports to be used in a dynamic operating mode with high filtering rate, with confinement of nanoparticles. Furthermore, as explained hereinabove, these membranes have the advantage of allowing an easy recovery of the catalysts at the end of their service life, for example by thermal degradation of the membranes. Thus, the precious metals that form the catalysts are recycled.

1. A method for manufacturing a membrane, wherein it comprises at least the following steps of:
a) preparing a mixture that contains at least:
an aqueous solution of a cationic polymer whose pH is comprised between 5 and 8, said cationic polymer having positively-charged groups in this aqueous solution;
an aqueous solution of an anionic polymer, said anionic polymer having negatively-charged groups in this aqueous solution;
b) stirring the mixture;
c) leaving the mixture to mature to cause the ionic interaction between positively-charged groups of the cationic polymer and negatively-charged groups of the anionic polymer, until obtaining within the mixture a membrane in the form of a hydrogel;
d) adding at least one crosslinking agent so as to crosslink the membrane;
e) drying the crosslinked membrane obtained upon completion of step d).

2. The method for manufacturing a membrane according to claim 1, wherein the cationic polymer is selected amongst polyethylenimine, polyallylamine hydrochloride, chitosans and proteins.

3. The method for manufacturing a membrane according to claim 1, wherein the anionic polymer is selected amongst polyacrylic acid, pectin, carrageenan, alginate and polystyrene sulfonate.

4. The method for manufacturing a membrane according to claim 1, wherein the mixture of step a) comprises, in weight percent expressed with respect to the weight of said mixture:
between 0.2% and 0.5% the cationic polymer;
between 0.6% and 1.5% of the anionic polymer.

5. The method for manufacturing a membrane according to claim 1, wherein at step a), at least one solid compound selected amongst activated charcoal, silica and clay is added to the mixture.

6. The method for manufacturing a membrane according to claim 1, wherein the crosslinking agent is glutaraldehyde.

7. A method comprising treating liquid or gaseous effluents with the membrane obtained according to the manufacturing method according to claim 1.

8. A method comprising supporting a heterogeneous catalysis with the membrane obtained according to the manufacturing method according to claim 1.

9. A method comprising applying the membrane obtained according to the manufacturing method according to claim 1 as an antimicrobial support.
